(19) United States
(12) Patent Application Publication
(10) Pub. No.: US 2020/0056039 A1
(43) Pub. Date: Feb. 20, 2020

(54) POLYAMIDE-BASED SLIDING MATERIAL

(71) Applicant: KS Gleitlager GmbH, St. Leon-Rot (DE)

(72) Inventors: Rolf REINICKE, Bad Schoenborn (DE); Ruediger BICKLE, Reilingen (DE); Steffen DICK, Kaiserslautern (DE)

(21) Appl. No.: 16/462,829

(22) PCT Filed: Nov. 22, 2017
(86) PCT No.: PCT/EP2017/080094

§ 371 Date: May 21, 2019

(30) Foreign Application Priority Data
Nov. 22, 2016 (DE) 10 2016 122 475.8
Nov. 22, 2016 (DE) 10 2016 122 476.6

(51) Int. Cl. C08L 77/06; C08K 3/013; C10M 169/04; F16C 33/20

(52) U.S. Cl. CPC C08L 77/06; C08K 3/013; C10M 169/04; F16C 33/201; C10M 2201/066; B33Y 70/00; C10M 2217/0443; C10N 2230/06; C10N 2240/02; C10N 2250/141; C10N 2250/18; C10M 2201/085

(57) ABSTRACT

The invention relates to a polyamide-based sliding material, having fillers that improve the tribological properties, wherein the fillers comprise at least one metal sulfide and/or calcium phosphate. The invention further relates to a plain-bearing composite material, having a metal support layer, in particular made of steel or bronze, optionally a porous carrier layer, in particular made of bronze, and a sliding material, which fills the pores in the carrier layer, and to a three-dimensional shaped body for sliding load, consisting of a sliding material, in particular produced as an injection-molded or extrusion part and/or by additive manufacturing. The invention further relates to a plain-bearing element produced from a plain-bearing composite material comprising a shaped body

This application claims priority to each of German Patent Application No. 102016122476.6 filed on Nov. 22, 2016 and German Patent Application No. 102016122475.8 filed on Nov. 22, 2016 the contents of each of which are incorporated by reference herein in their entireties.

### DESCRIPTION

The invention relates to a polyamide-based sliding material, having fillers that improve the tribological properties.

In the prior art, sliding materials that use polyamides are known. For example, unfilled polyamide 4.6 is used which, however, is not sufficiently wear-resistant for critical applications in the commercial vehicle sector.

In addition, a multiplicity of sliding materials are known which, for example, are PTFE-based and use polyamide merely as a filler.

Something similar is described, for example, in DE 10 2011 077 008 A1 which describes a PTFE-based plain-bearing composite material, in which fillers comprising thermoplastics and/or duroplasts and further tribologically effective substances are present together in compounded form in the polymer base of the sliding layer material.

The use of polyamides as solid lubricants in solvent-free, water-based polyamidimide lubricating lacquers is the subject matter of DE 10 2013 021 949 A1.

Proceeding from this prior art, the problem addressed by the invention is that of improving the tribological properties and particularly the wear resistance of polyamide-based sliding materials.

This problem is solved by a polyamide-based sliding material, wherein the fillers comprise one or more metal sulfides and calcium phosphate.

The invention further relates to a plain-bearing composite material according to claim 15, and to a three-dimensional shaped body according to claim 16, and to a sliding element according to claim 17.

Surprisingly, it has become apparent that the addition of one or more metal sulfides and calcium phosphate to the polyamide base significantly improves the wear resistance of the sliding material. The present sliding material is particularly suitable for uses outside of the motor in the automotive sector, particularly in grease-lubricated systems, such as commercial vehicle braking systems, knuckle joint bearings, etc. For such applications, there is the desire to use lead-free sliding materials. The present sliding material thus provides a material that has sufficient wear resistance.

For the sliding material according to the invention, a polyamide base is used as polymer base. This does not necessarily mean that the entire polymer base must be made of polyamide. Portions of up to 30% w/w of the polymer portion, particularly 20% w/w, and preferably only up to 10% w/w of the polyamide base can be substituted with other polymers and combinations thereof, particularly such as PTFE, but also, e.g., PVDF, PFA, FEP, ECTFE, ETFE. Preferably, the entire polyamide base consists to 100% w/w of polyamide.

According to a particularly preferred embodiment, it is provided that the polyamide base comprises PA 4.6, and particularly consists at least to 60% w/w, particularly to at least 70% w/w, particularly to at least 80% w/w, particularly to at least 90% w/w, and particularly to 100% w/w of PA 4.6.

For further improving the properties of the sliding material, particularly for a better compoundability of the materials, between 0% w/w and 40% w/w, particularly 1% w/w to 30% w/w, and particularly 5% w/w to 20% w/w, of further polyamides, which differ from PA 4.6, can additionally be used, particularly PA 6 and/or PA 6.6.

Particularly advantageous properties can be achieved if the portion of the one or more metal sulfides and/or the calcium phosphate totals 1% w/w to 30% w/w, particularly 1% w/w to 20% w/w, and particularly 5% w/w 15% w/w, particularly 10% w/w of the sliding material. Depending on the concrete selection of the fillers, it can also be particularly preferable if the portion of calcium phosphate and/or metal sulfides is 5% w/w in terms of the sliding material. It is particularly preferred if both the at least one metal sulfide and the calcium phosphate are used. In such case, the portion of the at least one metal sulfide is preferably 1 to 50% w/w, and the portion of the calcium phosphate is 50 to 99% w/w of the mixture of metal sulfide and calcium phosphate. In particular, the portion of metal sulfide is 3 to 40% w/w and that of calcium phosphate is 60 to 97% w/w. Furthermore, the portion of metal sulfide is particularly 5 to 30% w/w and that of calcium phosphate is 70 to 95% w/w.

Particularly preferably, mixtures of calcium phosphate and/or one or more metal sulfides, particularly MoS₂, SnS₂, WS₂, or bismuth sulfide, and combinations thereof can be used.

Particularly preferred is also the use of WS₂ without the addition of calcium phosphate.

Fillers with the following composition have proven to be particularly preferred:

2-20% w/w SnS₂,

70-97% w/w calcium phosphate

1-10% w/w WS₂.

The weight specifications refer to the sum of the weights of the three fillers. The sum of all portions equals 100% w/w. In terms of the weight of the sliding material, 1% w/w to 30% w/w, particularly 1% w/w to 20% w/w, and particularly 5% w/w to 15% w/w, particularly 10% w/w can subsequently be used in the sliding material from this composition. Depending on the concrete selection of the fillers, it can also be preferable if the portion of calcium phosphate and/or metal sulfides is 5% w/w in terms of the weight of the sliding material.

A further, particularly preferred composition of fillers is

50% w/w calcium phosphate

50% w/w WS₂

in terms of the sum of the weights of the two filler of the composition.

Particularly preferred are weight ratios of calcium phosphate to metal sulfide from 5:1 to 1:1.

For a preferred composition of the filler of SnS₂/calcium phosphate/WS₂ (in terms of WS₂), the preferred portions are as follows:

1-3 SnS₂,

9-13 calcium phosphate

1 WS₂, and particularly

1.67 SnS₂,

11 calcium phosphate

1 WS₂.

Alternatively, calcium phosphate and WS₂ at a ratio of 1:1 are particularly preferred as fillers.

Such filler compositions provide particularly favorable tribological properties.

In addition, it is also provided that only metal sulfides, particularly WS₂, are used as a filler, particularly with a portion of 10% % w/w in terms of the sliding material.

The fillers can additionally comprise further tribologically effective substances, e.g., reinforcing materials, particularly such as carbon fibers, glass fibers, polymer fibers (particularly aramid fibers); and/or solid lubricants, particularly such as PTFE, ZnS, BaSO₄, Graphite, soot, BN and/or plastic particles, particularly such as aramid (PPTA), PPSO₂, PI and PAI particles, polyacrylate particles (PAR), PBA particles, PBI particles; and/or metal oxides, particularly such as Fe₂O₃, Al₂O₃, SiO₂, CrO₂, TiO₂, CuO, MgO, ZnO; and/or hard material particles, particularly ceramic particles, such as SiC, Si₃N₄, BC, cubic BN; and/or fluorides, particularly such as CaF₂, NaF, AlF₃; and/or sheet silicates, particularly such as kaolin, mica, wollastonite, talcum, precipitated chalk, silicic acid; and/or metallic fine powders, particularly such as bronze and bismuth; and/or pigments or mixed-phase oxide pigments, particularly such as Co—Al, Cr—Sb—Ti, Co—Ti, Fe—Al, or Co—Cr.

It is particularly preferred if the portion of the further tribologically effective substances is 0% w/w to 40% w/w, particularly 1% w/w to 20% w/w, particularly 1% w/w to 10% w/w, particularly 5% w/w, of the sliding material.

Particularly preferred is the use of sheet silicates, particularly kaolin and/or wollastonite and/or talcum, and/or solid lubricants, particularly BaSo₄ and/or ZnS.

Particularly preferably, it is additionally provided that the polyamide base comprises 50% w/w to 95% w/w, particularly 60% w/w to 95% w/w, and particularly 70% w/w to 90% w/w of the sliding material. In this manner, the properties of the polyamide material can sufficiently influence the sliding material.

The sliding material can be used to produce a plain-bearing composite material, having a metal support layer, in particular made of steel or bronze, optionally a porous carrier layer, in particular made of bronze, and a sliding material of the previously described type, which fills the pores in the carrier layer. For that purpose, the sliding material with its fillers is extruded into a foil-like flat material, and said flat material is applied to a metal support layer or impregnated into the pores of the porous carrier layer, wherein preferably a hot pressing process and/or a rolling process is used for that purpose.

The invention further also relates to a three-dimensional shaped body for sliding load, consisting of a sliding material of the previously described type, in particular produced as an injection-molded or extrusion part. In addition, the shaped body can be attached to a carrier part made of a different material, in particular injection-molded onto said carrier part. However, mechanical or other types of integral bonding are also conceivable. Additive manufacturing methods, with which the shaped body can be produced, are also conceivable.

The plain-bearing composite material or the three-dimensional shaped body can be used as a plain-bearing element, wherein a plain-bearing element can be, for example, a sliding strip, a sliding shoe, a sliding pad, and a plain-bearing shell, a plain-bearing bushing, or a plain-bearing collar bushing. In case of a sliding shoe or a sliding strip, the measurements of the shaped body in every dimension are at least 1 mm, particularly at least 2 mm, and further particularly at least 5 mm, or at least 6 mm. In contrast, the measurements can naturally also be very much larger. In principle, shell shapes, particularly such as spherical shell shapes, bushings or collar bushings and further components are conceivable for the use of the shaped body.

In addition, sliding elements can also be typically rolled cylindrical bushings or half shell-shaped plain-bearing elements manufactured with a plain-bearing composite material. The plain-bearing composite material can also be used to manufacture collar bushings, or pot bushings, or plane and spherical plain-bearing elements.

| Example no . | Reference | 1 | 2 | 3 | 4 | 5 |
|---|---|---|---|---|---|---|
| Polyamide | 100% w/w | 80% w/w | 85% w/w | 80% w/w | 80% w/w | 75% w/w |
| base | PA 4.6 | PA 4.6 | PA 4.6 | PA 4.6 | PA 4.6 | PA 4.6 |
| | | 10% w/w | 7.5% w/w | 10% w/w | 10% w/w | 15% w/w |
| | | PA 6.6 | PTFE | PA 6.6 | PA 6.6 | PA 6.6 |
| | | | | | | 5% w/w |
| | | | | | | PTFE |
| Fillers | — | — | — | 10% w/w | 10% w/w | 5% w/w |
| | | | | WS₂ | mixture A | mixture A |
| Further | — | 10% w/w | 7.5% w/w | | — | — |
| tribologically | | kaolin | kaolin | | | |
| effective | | | | | | |
| substances | | | | | | |
| Wear | 174 | 189 | 117 | 83 | 71 | 64 |

| Example no . | 6 | 7 | 8 | 9 | 10 |
|---|---|---|---|---|---|
| Polyamide | 80% w/w | 80% w/w | 80% w/w | 70% w/w | 70% w/w |
| base | PA 4.6 | PA 4.6 | PA 4.6 | PA 4.6 | PA 4.6 |
| | 10% w/w | 10% w/w | 10% w/w | 15% w/w | 15% w/w |
| | PA 6.6 | PA 6.6 | PA 6.6 | PA 6.6 | PA 6.6 |
| | | | | 5% w/w | 5% w/w |
| | | | | PTFE | PTFE |
| Fillers | 5% w/w | 5% w/w | 5% w/w | 5% w/w | 5% w/w |
| | calcium | mixture A | mixture A | mixture A | mixture A |
| | phosphate | | | | |
| | 5% w/w WS₂ | | | | |
| Further | | 5% w/w | 5% w/w | 5% w/w | 5% w/w |
| tribologically | | barium sulfate | zinc sulfide | kaolin | talcum |
| effective | | | | | |
| substances | | | | | |
| Wear | 57 | 55 | 51 | 46 | 43 |

Mixture A: 1.67 portions SnS₂ to

11 portions calcium phosphate to

1 portion WS₂

The wear values in μm are plotted in the following drawing together with the parameters of the measurement:

The drawing shows that the addition of fillers of mixture A and the addition of calcium phosphate together with WS₂ or the addition of WS₂ alone as exemplary metal sulfide significantly lowers the wear values and thus improves the wear resistance.

The examples 3 to 10 shown above represent preferred compositions of the sliding material according to the invention, wherein the polyamide base if formed from two different polyamides with emphasis on PA 4.6 and partly PTFE, and portions of 5% w/w or 10% w/w of a mixture A of tin disulfide, calcium phosphate, and tungsten disulfide at the ratio 5:33:3% w/w were added, and, to some extent, a further tribologically effective substance, for example, 5% w/w barium sulfate, zinc sulfide, kaolin, or talcum was added in examples 7-10. An alternative composition of the fillers is shown in examples 3 and 6. Examples 1 to 2 are comparative examples. A sliding material made of PA 4.6 without fillers and further components is used as a reference.

1. A polyamide-based sliding material, comprising fillers that improve the tribological properties, wherein the fillers comprise at least one metal sulfide and calcium phosphate, and wherein the portion of the at least one metal sulfide and the calcium phosphate totals 1-30% w/w, of the polyamide-based sliding material, and wherein the weight ratio of calcium phosphate to metal sulfide is between 5:1 and 1:1.

2. The polyamide-based sliding material of claim 1, wherein the polyamide base of the polyamide-based sliding material comprise at least 70% w/w polyamide.

3. The polyamide-based sliding material of claim 1, wherein the polyamide base of the polyamide-based sliding material comprises PA 4.6.

4. The polyamide-based sliding material of claim 3, wherein the polyamide base of the polyamide-based sliding material further comprises 1-40% w/w of a polyamide, which is different from PA 4.6.

5. The polyamide-based sliding material of claim 1, wherein the portion of the at least one metal sulfide and the calcium phosphate totals 1-20% w/w of the polyamide-based sliding material.

6. (canceled)

7. The polyamide-based sliding material of claim 1, wherein the at least one metal sulfide is selected from the group consisting of SnS₂, MoS₂, bismuth sulfide, WS₂, and combinations thereof.

8. The polyamide-based sliding material of claim 7, wherein the fillers comprise:
2-20% w/w SnS₂,
70-97% w/w calcium phosphate, and
1-10% w/w WS₂.

9. The polyamide-based sliding material of claim 8, wherein the fillers are comprised in the weight ratios of
1-3 SnS₂ to
9-13 calcium phosphate to
1 WS₂.

10. The polyamide-based sliding material of claim 1, wherein the fillers comprise:
5% w/w calcium phosphate
5% w/w WS₂ based on the total weight of the polyamide-based sliding material.

11. The polyamide-based sliding material of claim 1, further comprising tribologically effective substances selected from the group consisting of reinforcing materials, solid lubricants, plastic particles, metal oxides, hard material particles, sheet silicates, metallic fine powders, and pigments.

12. The polyamide-based sliding material of claim 11, wherein the further tribologically effective substances are present in an amount of from 1-40% w/w based on the weight of the polyamide-based sliding material.

13. The polyamide-based sliding material of claim 11 wherein the further tribologically effective substances are sheet silicates present in an amount of from 1-40% w/w based on the total weight of the polyamide-based sliding material.

14. The polyamide-based sliding material of claim 1, wherein the polyamide base comprises 50-95% w/w of the polyamide-based sliding material.

15. A plain-bearing composite material, comprising a metal support layer, and the polyamide-based sliding material of claim 1.

16. A three-dimensional shaped body for sliding load, comprising the polyamide-based sliding material of claim 1.

17. A plain-bearing element produced from a plain-bearing composite material according to claim 15.

18. The plain-bearing element of claim 17, which is selected from the group consisting of a sliding strip, a sliding shoe, a sliding pad, a plain-bearing shell, a plain-bearing bushing, and a plain-bearing collar bushing.

19. A plain-bearing composite material, comprising a metal support layer, a porous carrier layer, and the polyamide-based sliding material of claim 1, wherein the polyamide-based sliding material fills the pores in the porous carrier layer

20. A plain-bearing element comprising the three-dimensional shaped body for sliding load of claim 16.
